(19) United States
(12) Patent Application Publication
(10) Pub. No.: US 2026/0275112 A1
(43) Pub. Date: Sep. 17, 2026

(54) METHOD OF MANUFACTURING GRANULES AND GRANULES THUS OBTAINED

(71) Applicant: PRTC NV, Tisselt (BE)

(72) Inventor: Oras ABDUL-KADER, Sint Niklaas (BE)

(21) Appl. No.: 19/469,475

(22) PCT Filed: Mar. 28, 2024
(86) PCT No.: PCT/EP2024/058683

§ 371 Date: Sep. 26, 2025

(30) Foreign Application Priority Data
Mar. 31, 2023 (EP) 23166028.3

(51) Int. Cl. C09C 3/06; C09C 1/00; C09C 3/00; C09C 3/04

(52) U.S. Cl. CPC C09C 3/063; C09C 1/0081; C09C 3/006; C09C 3/045; C01P 2004/50; C01P 2004/61; C01P 2004/84; C01P 2006/32

(57) ABSTRACT

A method of manufacturing of granules of microporous material is provided. It comprises the steps of: (1) providing a powder of microporous material, comprising an insulation powder such as pyrogenic silica, an opacifier and optionally a filler, (2) granulating the powder into granules, and (3) treating said granules with an aqueous composition of a silicic acid material, such as waterglass. The microporous powder composition suitably comprises the opacifier in an amount of 10-50 wt %, the insulation powder in an amount of 40-80 wt % and said filler in an amount of 0-50 wt %.

### FIELD OF THE INVENTION

The invention relates to a method of manufacturing granules comprising a microporous material, comprising the steps of providing a powder of a microporous material and granulating said powder into granules.

The invention further relates to granules comprising a microporous material.

The invention moreover relates to the transport of such granules and the use thereof for filling a space in an apparatus and acting as insulating material therein.

### BACKGROUND OF THE INVENTION

Microporous materials are known per se, for instance from GB1580909 and U.S. Pat. No. 6,936,326, and comprise a porous silica material which generally is either a pyrogenic silica or aerogel, and in addition thereto an opacifier and optionally a reinforcing fiber. Microporous materials are characterized by a very low thermal conductivity of less than 40 mW/m·K and even significantly lower and are often used as thin insulating panel in a variety of industrial applications as well as in construction. The microporous materials may be encapsulated in a rigid or flexible envelope or even be within a barrier material which is then drawn to vacuum. The latter panel is known per se as a vacuum insulation panel or VIP.

One of the forms in which microporous material is generated is a granulate. The granules offer the advantage that these can fill up a space of any complex shape and act therein as insulating material. This turns out advantageous in applications such as heaters, fuel cells and other thermal apparatus, wherein a certain part of the apparatus will operate at relatively high temperature, typically between 30° and 1000° C., while other portions of the apparatus should not heat up too much, for instance to avoid any burning by a user. The granules may here be inserted into channels, cavities and other shapes so as to enable appropriate insulation.

An important feature of such granules is their mechanical stability. When the granules disintegrate during transport or during the filling of any desired space, the density will go up, leading to a loss of insulating performance. Furthermore, dust may be generated, and effective handling may become more difficult.

### SUMMARY OF THE INVENTION

It is therefore a first object of the invention to provide a method of manufacturing granules of microporous material which leads to enhanced granule strength without significant loss of insulating performance as compared to commercially available granules.

It is a further object of the invention to provide granules of microporous material with enhanced granule strength without significant loss of insulating performance as compared to commercially available granules.

It is again a further object of the invention to provide use of said granules, particularly use in transporting and in filling spaces in apparatus to create insulation, for instance an insulating jacket.

According to a first aspect, the invention provides a method of manufacturing of granules of microporous material comprising the steps of: (1) providing a powder of microporous material; (2) granulating the powder into granules, and (3) treating said granules with an aqueous composition of a silicic acid material.

According to a second aspect, the invention relates to granules obtainable with the method of the invention.

According to a third aspect, the invention relates to granules comprising microporous powder material, wherein individual particles within the granules are physically and/or chemically bonded by means of a silicic acid, optionally converted into silica.

According to a fourth aspect, the invention relates to the use of granules of the invention and/or obtained in accordance with the invention for filling a space in an apparatus and creating an insulating layer.

The invention is based on the insight that the treatment of granules of microporous material with an aqueous silicic acid material strengthens the granules without significantly increasing the thermal conductivity of the granules. This has been proven by experiments. It was moreover found that dusting of the granule material can be reduced significantly.

It is believed, that the silicic acid material may chemically or physically bond individual particles within the granules. Herein the silicic acid material applied to the granules in aqueous composition may be a precursor for the material that bonds the individual particles. As is known from textbooks of silicic acid and silica, silicic acid is an oligomeric or polymeric material that can convert into silica by means of reactions between silicic acid groups Si—OH within the silica. The further polymerization of monomeric, dimeric and oligomeric silicic acid proceeds in dependence of the conditions in which the silicic acid is kept. It may be stabilized in the form of a colloidal suspension by means of stabilizing agents, including ammonium ions, metal ions and in dependence of the pH of the aqueous composition. The reaction of silicic acid may also include silicic acid groups on a surface, such as those of the individual particles of the microporous material.

According to a preferred embodiment, the silicic acid material is chosen from the group of water glass, ammonium silicate, sodium silicate, potassium silicate, sodium metasilicate, potassium metasilicate, an alkali or earth alkali salt of silicic acid, orthosilicic acid, metasilicic acid, pyrosilicic acid, disilicic acid, trisilicic acid, tetrasilicic acid, oligomeric and polymeric silicic acid, silica gel, and its mixtures. These are all silicic acids or precursors thereof that may under appropriate conditions generate polymeric silicic acid and be converted into silica.

In a preferred implementation, the silicic acid material and the aqueous composition are alkaline. Examples thereof are silicate solutions or colloidal compositions. It is believed that the pH of the silicic acid material may decrease upon contact with the microporous material. The aerogel and particularly pyrogenic silica therein are typically slightly acidic or neutral. Hence, when the aqueous composition contacts the microporous material, its alkaline pH likely decreases, which may lead to changes in the stability of the silicic acid and may lead to formation of silica, for instance to fill up pores between particles.

With particular preference, the water-soluble silicate compound is selected from an alkali metal silicate of the formula m SiO2·n M2O, where M is Li, Na, K, and NH4, preferably Na or K, or mixtures thereof, m and n are molar numbers, and the ratio of min is about 0.9 to about 4, preferably about 0.9 to about 3.8, and more particularly about 0.9 to about 3.6. The term “waterglass” refers to water-soluble salts of the silicic acids that have solidified from the fluid melt, more particularly potassium silicate and sodium silicate or their aqueous solutions, as found under the entry heading “Waterglass” (such as updated in May 2004) in the online reference work ROMPP (Thieme Verlagsgruppe). Most preferred is the use of water glass.

In the context of the invention, it is not excluded that the silicate composition comprises further cations such as calcium, aluminium. However, crystalline calcium silicates, such as with a molar ratio between Ca and Si around 1, such as also known as tobermorite, xonotlite and the like, are not adequate, as they do not show the behaviour of the silicic acid materials.

The microporous material preferably comprises a finely divided metal oxide. As finely divided metal oxides, e.g., pyrogenically prepared silicic acids including are silicic acid, precipitated low-alkali silicic acids, silicon dioxide aerogels, analogously prepared aluminium oxides and mixtures thereof are used. Pyrogenically prepared silicic acids, also known as pyrogenic silica, are especially preferred. Good granulation results have been obtained with this material.

In a particularly preferred embodiment, the silica acid material comprises earth alkali ions and is most preferably water glass. Tests have shown that the silica acid material comprising earth alkali ions may act as an anticorrosion agent. The silicic acid with said ions may act as a getter for chlorine ions or compounds available in small quantities, for instance in the range up to 500 ppm, more preferably up to 250 ppm, as a consequence of the production of pyrogenic silica. The said chlorine ions or compounds may migrate through the granules particularly at higher temperatures, for instance of 300° C. or higher. The term ‘chlorine ions or compounds’ is used to cover any form in which the chlorine would migrate, such as chloride ions, or chlorosilane compounds or radicals or chlorite or chlorate anions. It is observed that the exact chemical nature of the migrating compounds is not known. The amount of silica such as pyrogenic silica in the powder mixture is for instance in the range 30 to 90% by weight, such as 40 to 80%, for instance 60 to 80% without any filler and 40 to 60% by weight with a filler.

According to a further embodiment, the microporous material furthermore comprises an opacifier. As opacifiers, titanium dioxide, ilmenite, silicon carbide, iron (II) iron (III) mixed oxides, chromium dioxide, zirconium oxide, manganese dioxide, iron oxide, silicon dioxide, aluminium oxide, and zirconium silicate, and mixtures thereof can be used. Above all, said opacifiers are used to absorb and scatter infrared radiation and thus provide a good insulation against heat radiation of the higher temperature range. The amount of opacifiers in the microporous powder mixture is for instance in the range of 0 to 40%, for instance 20 to 30%.

According to again a further embodiment, the microporous material may further comprise a filler and especially a powdery filler, preferably of inorganic nature. Examples of such fillers include calcium silicate, for instance in the form of xonotlite, such as xonotlite core-shell particles, microsilica, perlite, aluminium phosphates, borides of aluminium, titanium, zirconium, calcium; silicides such as calcium silicide and calcium aluminium silicide, boron carbide and basic oxides such as magnesium oxide, calcium oxide, and barium oxide. Fillers may be used in the powder mixture up to 40 wt %, preferably from 5 to 25 wt % (total amount for all fillers).

In one preferred implementation, the amount of fillers in the powder composition and the addition of the silicic acid material added as a post-treatment is limited to 25% by weight in the powder composition and 15% by weight added as a post-treatment. More preferably, said addition is limited to 20% of the powder composition and 10% in the post treatment. Even more preferably, the added up amounts of said fillers in the powder composition and said silicic acid material is limited to 20% of the granule weight. In preliminary experiments, the thermal conductivity without any filler or agent was found to be 40 mW/m·K at 400° C. and a tap density of 240 g/l. At such densities, an addition of either 20% filler to the powder composition or 12% addition of an agent in a post-treatment, was found to lead to an increase of the thermal conductivity with 15-20%. Such an addition appears at a top edge of an acceptable thermal conductivity, which is 50 mW/m·K for at least one application. More preferably, the thermal conductivity is at most 45 mW/m·K. Improvements in the thermal conductivity may be achieved by lowering the tap density.

In a further embodiment, the content of microporous material in the granules, before the treatment, is at least 90 wt %. As discussed hereinabove, said microporous material comprises the finely divided metal oxide, the opacifier and any filler. Preferably, the granules consist of microporous material, before the treatment with the aqueous composition. In other words, no organic binder is added prior to granulation, in order to keep the insulation performance as high as possible.

In one implementation, the microporous powder composition comprises the opacifier in an amount of 10-50 wt %, the insulation powder in an amount of 40-80 wt % and said filler in an amount of 0-50 wt %. This has been observed to provide an acceptable powder composition for granulation. Preferably, the powder composition is free of any reinforcing fibers. More preferably, the microporous powder composition comprises the opacifier in an amount of 20-35 wt %, the insulation powder in an amount of 40-80 wt % and said filler in an amount of 0-25 wt %. Most preferably, the microporous powder composition is substantially free of any further ingredients beyond said insulation powder, said opacifier and said filler; in other words, the amounts of said three ingredients add up to at least 98% by weight, preferably at least 99% by weight, more preferably at least 99.5% by weight or even 100% by weight. Any further ingredient may be a hydrophobizing agent, a biocide, pigment and the like. Rheological agents or processing aids are not deemed necessary but cannot be excluded.

The chosen powder mixture, is, after mixing and any optional further treatments, granulated. Preferably, dry granulation is used. Herein the microporous material is first compacted and shaped, or alternatively extruded, and then cut to a desired granule size. Good results were obtained with a granule size in the range of 0.2 to 4 mm, for instance 0.3 mm to 2.5 mm. It may be advantageous to specify the granule size further, for instance in the range of 1 to 2.5 mm, such as 1.5 mm to 2.5 mm, or alternatively in the range of 0.5 to 1.2 mm. These sizes are defined by sieving. Such may further contribute to improved transporting, storage, and to homogeneous application of the silicic acid material. A smaller granule size may be preferred when using less silicic acid material. A larger granule size may be preferred for transport and storage. In a preferred implementation, the granulation comprises a roller-compaction step. This has been found to provide homogeneous granules.

The treatment step with the aqueous composition of a silica acid material may be performed by any known method of applying a liquid to a surface, including spraying, spattering, printing, sprinkling said aqueous composition, arranging said granules in a chamber provided with an atmosphere of droplets of said aqueous composition, for instance in the form of a mist and submerging said granules in a bath of said aqueous composition. It has been observed that no specific drying step is necessary, although the application of a heating step is not excluded. Good results have been obtained in initial experiments with spraying, but that is not considered as the only feasible method.

Preferably, the granules are treated with the aqueous composition at a weight ratio between the aqueous composition and the granules of at most 0.2, preferably at most 0.1, or even at most 0.05, wherein said weight ratio is based on the dry weight of the aqueous composition. The application of the aqueous composition in a lower weight ratio is considered beneficial. At higher ratios, above 0.1, a decrease in insulation performance was observed. This may be due to the silicic acid material adsorbing on surfaces of the granules and/or between the granules rather than inside the granules. The weight ratio may be further reduced to at most 0.05 or even at most 0.04, at most 0.03 or at most 0.02.

In a further implementation, the aqueous composition comprises additional compounds in addition to the silicic acid material. Such additional compounds may be processing aids, including rheology aids, stabilizers such as biocides and/or hydrophobation agents, colorants, and fillers such as microsilica.

The granulate of the present invention is very suitable for filling a space in an apparatus to create an insulating layer. Furthermore, the granulate may be transported and/or stored in bulk prior to such filling. Bulk storage can occur in a storage container such as a silo. In a preferred implementation, the bulk storage in the storage container occurs up to a maximum height of 3.0 meter, more preferably in the range of 1.5 to 2.5 meters, for instance 2 meter or 1.5-2 meter. While conventional storage containers for powders have a height of 10 or 20 meters, storage of the present low-density granules comprising microporous powder composition is better done in a container having a low maximum height. Otherwise, the pressure on granules may exceed the granule strength, leading to unforeseen damage. For transportation in bulk, corresponding height limitations are preferably followed. More preferably, use is made of a moving floor trailer. Preferably, such a trailer has a maximum volume of 65 m³. In this manner, mechanical stresses during the loading and unloading process will be limited. After transport, the granules may be fed with the moving floor technology over a hopper facility into a storage container, such as a modular silo system. Granules may be unloaded from such a storage container and transported to a filling location using conveyers for powder. Preferably, use is made of a tube drag chain conveyors system. This system can additionally be used for loading a truck. The silo is much wider than high to achieve the needed storage volume and to ensure/provide the maximum storage height.

Rather than directly after granulation, the treatment step may be performed after transport of the granules to a customer, where such granules will be used for filling a space. Such a treatment may reduce dusting and optionally re-create granules within a predefined size range. Such treatment at a customer site may be an additional treatment to a treatment directly after granulation. The treatment conditions do not need to be equal. Particularly, in case of an additional treatment step, the amount of aqueous silicic acid material per weight of granules may be less.

It is observed for clarity that any of the embodiments discussed hereinbefore, hereinafter and/or specified as dependent claims may be combined with any aspect of the invention, as far as applicable.

### EXAMPLES

These and other aspects of the invention will be further elucidated in the following examples, which are exemplary in nature.

### Measurement Methods

Compressive strength is measured in following manner: granules are pressed into a metal die. A universal test machine of 500 kN load cell is used with cross head speed of 1 mm/min. The maximum force and displacement are recorded continuously during compression and the stress is calculated therefrom.

Tap or tapped density is an increased bulk density attained after mechanically tapping a receptacle containing the sample of powder or granule. The tapped bulk density is obtained by mechanically tapping a graduated measuring cylinder or vessel containing the sample. After observing the initial untapped bulk volume (V0) and mass (m0) of the sample, the measuring cylinder or vessel is mechanically tapped, and volume or mass readings are taken until little further volume or mass change is observed. The mechanical tapping is achieved by raising the cylinder or vessel and allowing it to drop, under its own mass, a specified distance. Devices that rotate the cylinder or vessel during tapping may be preferred to minimize non-uniformity during tapping down.

Thermal conductivity is measured at equilibrium using a cell with a diameter of 110 mm and a height of 100 mm. A heat source in the form of a cylindrical heating element is hanged in the middle with controlled power supply. Insulation is present circumferential to the cylindrical heating element. At the outside, a metal can is present. The thermal conductivity of the material is obtained from the temperature difference (between hot/cold face temperatures) and heat transfer cross cylindrical section. An effective area for the heat transfer is calculated, and hot & cold face temperatures (HF, CF) are recorded. The thermal conductivity γ in mW/mK is calculated as γ=0.956×Power supply/ΔT(HF−CF)−0.0036. This method has been developed by applicant in collaboration with the National Physical Laboratory (NPL) in the UK. The resulting values for the thermal conductivity are approximately 15% higher than those measured in accordance with ISO 8302.

Shrinkage at 1000° C. during 24 hours was measured by putting the granules in a cylindrical cup in an oven at 1000° C. during 24 hours, and measuring the volume shrinkage by comparing the height level before and after the heat treatment.

### Example 1

Microporous powder compositions were generating by mixing pyrogenic silica as insulation powder, and silicon carbide as opacifier in a weight ratio of 70:30. The pyrogenic silica had a specific surface area in the range of 200-250 m2/g as measured by the BET method. The powder compositions were thereafter subjected to dry granulation, which comprises a roller-compaction step using equipment provided with at least two counter-rotating rollers, between which the powder composition is continuously compressed using a controlled compaction force. The compaction force or pressure was set to achieve a desired tap density, which was 240 g/l in the examples. The bulk density was 200 g/l. The dry granulation furthermore included a size reduction step downstream of said roller-compaction step. Use was made of a sieve mill. The final sieve size in the sieve mill was set to 310 microns. The granule size was such that at least 70 wt % of the granules had a size within the range 0.25 mm and 2.00 mm. In all examples, the granule formation was identical.

Subsequently, the resulting granules were subjected to a treatment using an aqueous composition of water glass. Use was made of sodium-based water glass as commercially available, also known as Sodium trisilicate solution, with formula Na₂O(SiO₂)ₓ·xH₂O or alternatively (NaOH)ₓ·(Na₂SiO₃)_{y}·zH₂O, and particularly Na₂O₇Si₃. The solution was used without dilution, and sprayed onto the granules. The amount of sprayed composition was calculated based on the desired total content of water glass in the granules. After spraying, the granules were left to dry at room temperature.

As a reference, a composition of siloxane was sprayed. The composition was an aqueous emulsion based on a mixture of silane and siloxane as supplied by Wacker under tradename SILRES™ BS3003. The resulting granules were thereafter tested for different parameters, including thermal conductivity at 200° C. and at 400° C., dust concentration (as defined as material with a size smaller than 250 microns) and compressive strength (also referred to as granule strength). Results are found in Table 1.

TABLE 1
test results

| | Refer- | Compar- | Inven- | Inven- |
|---|---|---|---|---|
| Example | ence | ative | tion-1 | tion-2 |
| Spraying agent | None | Siloxane | Water | Water |
| | | | glass | glass |
| Amount (wt % of | — | 12% | 6% | 12% |
| granules) | | | | |
| Thermal conductivity at | 30 | 31 | 30 | 33 |
| 200° C. (mW/m · K) | | | | |
| Thermal conductivity at | 40 | 40 | 42 | 48 |
| 400° C. (mW/m · K) | | | | |
| Dust (wt %) | 7% | 7% | 0% | 0% |
| Granule strength (kPa) | 155 | 157 | 164 | 174 |

It can be seen in Table 1, that the spraying of water glass onto the granules significantly decreases the dust and additionally increases the granule strength. The thermal conductivity at 200° C. for the example in which 6% water glass was sprayed, is not increased in comparison to the reference. The thermal conductivity at 400° C. is somewhat increased, but still adequate. The increase in thermal conductivity was larger for the sample with 12% water glass, but still within acceptable limits. It is to be understood, that these data are based on preliminary experiments in which neither the amount of water glass nor the tap density was optimized. Based on the data from these preliminary experiments, it is apparent that the amount of water glass may be reduced to less than 10% and optionally even to less than 5% with a beneficial effect on dust removal. Furthermore, the granule strength is sufficient to reduce the tap density further down, which will lead to a reduction in thermal conductivity. The siloxane spraying on the contrary is not effective at all for reduction of dust. The increase in granule strength does not appear significant.

### Example 2

Further comparative examples were performed in which the powder composition was modified by inclusion of a filler. The amount of filler was 20%, the amount of pyrogenic silica was 50% and the amount of opacifier was 30%, all in weight percent. The calcium silicate filler was a xonotlite particle, as specified in U.S. Pat. No. 6,936,326. All samples were granulated to a tap density of 240 g/l and a bulk density of 200 g/l, and the granule size distribution was in accordance with example 1. No treatment was performed on the resulting granules.

TABLE 2
test results

| Example | Reference | Comparative 1 | Comparative 2 | Comparative 3 |
|---|---|---|---|---|
| Filler | None | Perlite | Water glass | Calcium silicate |
| Thermal conductivity at | 30 | 32 | 32 | 33 |
| 200° C. (mW/m · K) | | | | |
| Thermal conductivity at | 40 | 46 | 47 | 46 |
| 400° C. (mW/m · K) | | | | |
| Dust (wt %) | 7% | 9% | 6% | 7% |
| Granule strength (kPa) | 155 | 159 | 177 | 159 |
| Shrinkage at 1000° C. (%) | <3 | <5 | <5 | <3 |

The results in Table 2 indicates that the addition of fillers in the microporous powder composition does not result in a decrease of the dust level. Furthermore, for both the perlite and water glass additions, the resulting shrinkage at 1000° C. is more than 3%, which is above the desired limits as currently specified for the commercially available granules. The increase in granule strength is high for the water glass addition, but low for any other filler. The increase in thermal conductivity at 400° C. is almost 20%.

1. A method of manufacturing of granules of microporous material comprising the steps of:
Providing a powder of microporous material
Granulating the powder into granules, and
Treating said granules with an aqueous composition of a silicic acid material.

2. The method of claim 1, wherein the silicic acid material is chosen from the group of water glass, ammonium silicate, sodium silicate, potassium silicate, sodium metasilicate, potassium metasilicate, an alkali or earth alkali salt of silicic acid, orthosilicic acid, metasilicic acid, pyrosilicic acid, disilicic acid, trisilicic acid, tetrasilicic acid, oligomeric and polymeric silicic acid, silica gel, and its mixtures.

3. The method of claim 1, wherein the granules are treated with the aqueous composition at a weight ratio between the aqueous composition and the granules of at most 0.2, wherein said weight ratio is based on the dry weight of the aqueous composition.

4. The method of claim 1, wherein the treatment of said granules occurs by one or more of following: spraying, printing, sprinkling said aqueous composition, arranging said granules in a chamber provided with an atmosphere of droplets of said aqueous composition, submerging said granules in a bath of said aqueous composition.

5. The method of claim 1, wherein the granulating step comprises dry granulation.

6. The method of claim 5, wherein the granules are formed with a granule size in the range of 0.2 to 3 mm, as defined by sieving.

7. The method of claim 5, wherein the granulating step comprises a sieving step, wherein granules outside a predefined granule size are rejected.

8. The method of in claim 7, wherein the treatment of said granules with said aqueous composition is performed simultaneously with said sieving step or directly after said sieving step.

9. The method of claim 1, wherein said treatment of said granules is performed or reperformed after transport of said granules to a location at which the granules are used for filling any space in an apparatus to create an insulation.

10. The method of claim 1, wherein said powder of microporous material comprises a powder mixture of pyrogenic silica and an opacifier.

11. Granules of microporous material obtainable by the method of claim 1.

12. Granules comprising microporous powder material obtainable by the method of claim 1, wherein individual particles within the granules are physically and/or chemically bonded by means of a silicic acid, optionally converted into silica.

13. Granules of claim 11, wherein said individual particles within said granules comprise pyrogenic silica.

14. Granules of claim 11, wherein the granules have a granule size in the range of 0.2 to 3 mm, as defined by sieving.

15. Use of the granules of claim 11 for filling a space in an apparatus and creating an insulating layer.

16. The method of claim 3, wherein the granules are treated with the aqueous composition at a weight ratio between the aqueous composition and the granules of at most 0.1.

17. The method of claim 3, wherein the granules are treated with the aqueous composition at a weight ratio between the aqueous composition and the granules of at most 0.05.

18. The method of claim 6, wherein the granules are formed with a granule size in the range of 0.3 to 2.5 mm, as defined by sieving.

19. The granules of claim 14, wherein the granules have a granule size in the range of 0.3 to 2.5 mm, as defined by sieving.
